(19) United States
(12) Patent Application Publication
(10) Pub. No.: US 2026/0052579 A1
(43) Pub. Date: Feb. 19, 2026

(54) ENHANCED MSG1/MSGA TRANSMISSION FOR EARLY INDICATION OF USER EQUIPMENT FEATURES

(71) Applicant: QUALCOMM Incorporated, San Diego, CA (US)

(72) Inventor: Linhai HE, San Diego, CA (US)

(21) Appl. No.: 19/220,989

(22) Filed: May 28, 2025

Related U.S. Application Data
(60) Provisional application No. 63/682,972, filed on Aug. 14, 2024.

(51) Int. Cl. H04W 74/0833; H04W 24/08; H04W 74/00

(52) U.S. Cl. CPC H04W 74/0833; H04W 24/08; H04W 74/004

(57) ABSTRACT

Various aspects of the present disclosure generally relate to wireless communication. In some aspects, a user equipment (UE) may receive, from a network node, a physical random access channel (PRACH) configuration associated with multiple UE feature combinations supported by the network node. The UE may transmit, to the network node, a PRACH message including a UE feature indicator in a RACH occasion associated with the PRACH configuration. Numerous other aspects are described.

### CROSS-REFERENCE TO RELATED APPLICATION

This Patent application claims priority to U.S. Provisional Patent Application No. 63/682,972, filed on Aug. 14, 2024, entitled “ENHANCED MSG1/MSGA TRANSMISSION FOR EARLY INDICATION OF USER EQUIPMENT FEATURES,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods for enhanced MSG1/MSGA transmission for early indication of user equipment features.

### DESCRIPTION OF RELATED ART

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to an apparatus for wireless communication. The apparatus may include one or more memories and one or more processors coupled to the one or more memories. The one or more processors may be individually or collectively configured to receive, from a network node, a physical random access channel (PRACH) configuration associated with multiple user equipment (UE) feature combinations supported by the network node. The one or more processors may be individually or collectively configured to transmit, to the network node, a PRACH message including a UE feature indicator in a RACH occasion associated with the PRACH configuration.

Some aspects described herein relate to an apparatus for wireless communication. The apparatus may include one or more memories and one or more processors coupled to the one or more memories. The one or more processors may be individually or collectively configured to transmit, to a UE, a PRACH configuration associated with multiple UE feature combinations supported by the network node. The one or more processors may be configured to receive, from the UE, a PRACH message including a UE feature indicator in a RACH occasion associated with the PRACH configuration. The one or more processors may be individually or collectively configured to transmit, to the UE, a random access response (RAR) message including a confirmation indication associated with the UE feature indicator.

Some aspects described herein relate to a method of wireless communication performed by a UE. The method may include receiving, from a network node, a PRACH configuration associated with multiple UE feature combinations supported by the network node. The method may include transmitting, to the network node, a PRACH message including a UE feature indicator in a RACH occasion associated with the PRACH configuration.

Some aspects described herein relate to a method of wireless communication performed by a network node. The method may include transmitting, to a UE, a PRACH configuration associated with multiple UE feature combinations supported by the network node. The method may include receiving, from the UE, a PRACH message including a UE feature indicator in a RACH occasion associated with the PRACH configuration. The method may include transmitting, to the UE, an RAR message including a confirmation indication associated with the UE feature indicator.

Some aspects described herein relate to a non-transitory computer-readable medium that stores a set of instructions for wireless communication by a UE. The set of instructions, when executed by one or more processors of the UE, may cause the UE to receive, from a network node, a PRACH configuration associated with multiple UE feature combinations supported by the network node. The set of instructions, when executed by one or more processors of the UE, may cause the UE to transmit, to the network node, a PRACH message including a UE feature indicator in a RACH occasion associated with the PRACH configuration.

Some aspects described herein relate to a non-transitory computer-readable medium that stores a set of instructions for wireless communication by a network node. The set of instructions, when executed by one or more processors of the network node, may cause the network node to transmit, to a UE, a PRACH configuration associated with multiple UE feature combinations supported by the network node. The set of instructions, when executed by one or more processors of the network node, may cause the network node to receive, from the UE, a PRACH message including a UE feature indicator in a RACH occasion associated with the PRACH configuration. The set of instructions, when executed by one or more processors of the network node, may cause the network node to transmit, to the UE, an RAR message including a confirmation indication associated with the UE feature indicator.

Some aspects described herein relate to an apparatus for wireless communication. The apparatus may include means for receiving, from a network node, a PRACH configuration associated with multiple UE feature combinations supported by the network node. The apparatus may include means for transmitting, to the network node, a PRACH message including a UE feature indicator in a RACH occasion associated with the PRACH configuration.

Some aspects described herein relate to an apparatus for wireless communication. The apparatus may include means for transmitting, to a UE, a PRACH configuration associated with multiple UE feature combinations supported by the apparatus. The apparatus may include means for receiving, from the UE, a PRACH message including a UE feature indicator in a RACH occasion associated with the PRACH configuration. The apparatus may include means for transmitting, to the UE, an RAR message including a confirmation indication associated with the UE feature indicator.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification, and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network.

FIG. 3 is a diagram illustrating an example disaggregated base station architecture in accordance with the present disclosure.

FIG. 4 is a diagram illustrating an example of a four-step random access procedure, in accordance with the present disclosure.

FIG. 5 is a diagram illustrating an example of a two-step random access procedure, in accordance with the present disclosure.

FIG. 6 is a diagram illustrating an example associated with physical random access channel (RACH) configurations associated with different feature combinations, in accordance with the present disclosure.

FIGS. 7-8 are diagrams of examples associated with enhanced message 1 (MSG1) transmissions for early indication of UE features in a four-step RACH procedure, in accordance with the present disclosure.

FIGS. 9-10 are diagrams of examples associated with enhanced message A (MSGA) transmissions for early indication of UE features in a two-step RACH procedure, in accordance with the present disclosure.

FIG. 11 is a diagram illustrating an example process performed, for example, at a UE or an apparatus of a UE, in accordance with the present disclosure.

FIG. 12 is a diagram illustrating an example process performed, for example, at a network node or an apparatus of a network node, in accordance with the present disclosure.

FIGS. 13-14 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a wireless network, a random access channel (RACH) procedure is a sequence of steps to establish or re-establish communication between a network node and a user equipment (UE). For example, the RACH procedure may be utilized to achieve downlink (DL) and/or uplink (UL) synchronization between a UE and a network node and/or to obtain resources for a radio resource control (RRC) connection request. Prior to or as part of a RACH procedure, a network node broadcasts configuration and synchronization information to UEs, including a set of predefined preamble sequences that the UE may use to connect or re-connect with a network node. For example, the UE selects a preamble sequence and transmits the preamble to the network node on a physical random access channel (PRACH), thus enabling the network node to identify the UE and to further communicate with the UE.

In general, the RACH procedure may be implemented via a four-step RACH procedure or a two-step RACH procedure. In a four-step RACH procedure, for example, a network node may transmit one or more synchronization signal blocks (SSBs) and/or random access configuration information, which includes parameters to be used in the RACH procedure, including a listing of potential preambles. In response, a UE may transmit a message (e.g., a message 1, also referred to as a msg1 or MSG1) that includes a preamble selected from the listing of potential preambles. In response to receiving the UE message including the selected preamble, the network node may transmit a random access response (RAR) message (e.g., a message 2, also referred to as a msg2 or MSG2) indicating the detected preamble in MSG1 of the UE. Following the transmission of MSG2, the network node and UE continue communications to establish or re-establish a connection.

Alternatively, in a two-step RACH procedure, a UE may transmit a message (e.g., a message A, also referred to as msgA or MSGA) including a random access message payload that may include some or all of the contents of MSG1 and MSG3 of a four-step random access procedure. In response to receiving the MSGA, the network node may transmit an RAR message (e.g., a message B, also referred to as msgB or MSGB) that may include some or all of the contents of the MSG2 and MSG4 of a four-step random access procedure. Following the transmission of MSGA and MSGB, the network node and UE continue communications to establish or re-establish connection.

Furthermore, in both the two-step and four-step RACH procedures, the network node may utilize a RACH configuration to inform the UE of the possible feature combinations that are supported by the wireless network, where separate RACH resources are allocated for each possible feature combination supported by the wireless network.

When a wireless network adopts support for new UE features (e.g., reduced capability (RedCap), small data transmission (SDT), coverage enhancement (CovEnh), network slicing, or the like), a UE may utilize the RACH procedure to indicate the type or service (e.g., new features) of the UE, where each new supported feature is included in a possible combination of supported features that is layered onto prior (e.g., legacy) features. For example, a network node may configure separate, dedicated RACH resources and/or RACH configurations for each new supported feature as well as each feasible combination of supported features. Furthermore, based on a time and/or frequency resource (e.g., a RACH occasion) in which the network node receives a PRACH preamble, the network node can determine the feature(s) associated with the UE that has initiated the RACH request (e.g., the determination can be made prior to completion of the RACH procedure and before the UE is RRC connected).

In such examples, any feasible combination of features (e.g., a combination of RedCap, SDT, and network slicing) supported by a network node requires a dedicated RACH configuration for each combination of features. As a result, the possible number of feature combinations may increase significantly as the number of new features increases. Accordingly, this process of utilizing RACH resources to communicate the possible number of feature combinations is not scalable and results in complex signaling communications and an inefficient use of network resources.

Various aspects described herein generally relate to a UE signaling a feature combination of the UE when initiating a RACH procedure. Some aspects more specifically relate to a UE utilizing a MSG1 or MSGA communication to signal the feature combination of the UE. In some aspects, a network node may utilize a single PRACH configuration for various supported UE feature combinations, and a UE utilizes the single PRACH configuration to signal the feature combination of the UE when the UE transmits a MSG1 or MSGA to initiate the RACH procedure. For example, a network node may broadcast an index of the feature combinations supported by the network node, and in response, a UE may transmit, to the network node, a PRACH message (e.g., a MSG1 or MSGA) that includes a preamble sequence as well as a feature indicator that indicates a feature and/or feature combination supported by the UE, or a feature and/or feature combination supported by the network node that is closest to a feature and/or feature combination supported by UE.

Particular aspects of the subject matter described in this disclosure can be implemented to realize one or more of the following potential advantages. In some examples, the described techniques can be used to improve network efficiencies, where separate RACH resources and/or dedicated RACH configurations are not required for each and every feasible feature combination. In some other examples, the described techniques can be used to reduce signaling complexity by permitting the UE to explicitly signal the feature combination that triggers a RACH procedure over a single PRACH configuration.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, RedCap UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

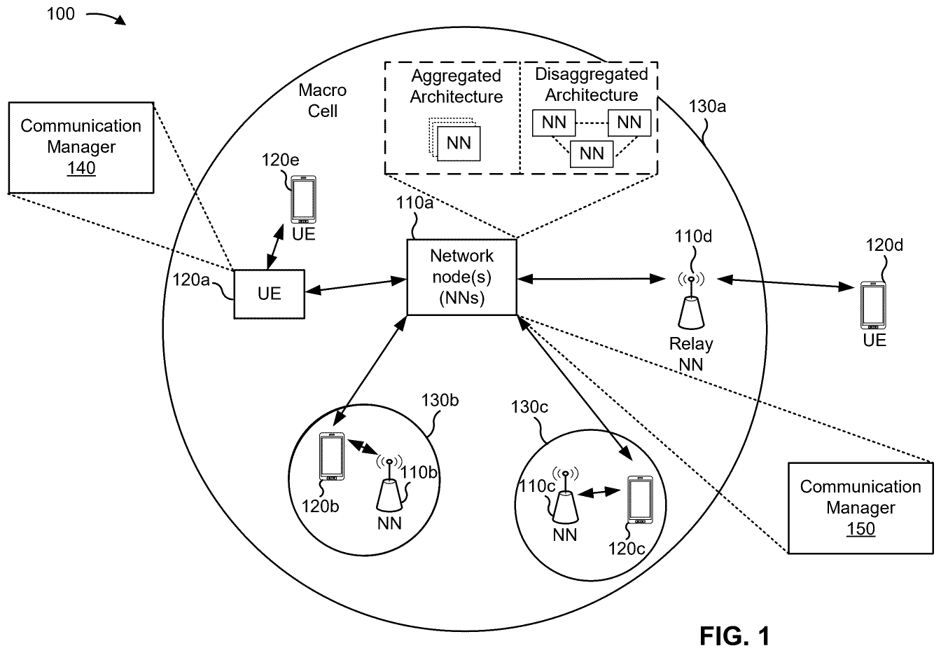

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHZ). Although a portion of FR1 is greater than 6 GHZ, FR1 is often referred to (interchangeably) as a “Sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, PRACH extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a DL and an UL. “Downlink” (or “DL”) refers to a communication direction from a network node 110 to a UE 120, and UL refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). UL channels may similarly include one or more control channels and one or more data channels. An UL control channel may be used to transmit uplink control information (UCI) (for example, reference signals and/or feedback corresponding to one or more downlink transmissions) from a UE 120 to a network node 110. An UL data channel may be used to transmit UL data (for example, user data associated with a UE 120) from a UE 120 to a network node 110. UL control channels may include one or more physical uplink control channels (PUCCHs), and UL data channels may include one or more physical uplink shared channels (PUSCHs). The downlink and the UL may each include a set of resources on which the network node 110 and the UE 120 may communicate.

DL and UL resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an UL BWP and a DL BWP (where the UL BWP and the DL BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced cMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (cMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or cMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive, from a network node 110, a PRACH configuration associated with multiple UE feature combinations supported by the network node 110; and transmit, to the network node 110, a PRACH message including a UE feature indicator in a RACH occasion associated with the PRACH configuration. Additionally, or alternatively, the communication manager 140 may perform one or more other operations described herein.

In some aspects, the network node 110 may include a communication manager 150. As described in more detail elsewhere herein, the communication manager 150 may transmit, to a UE 120, a PRACH configuration associated with multiple UE feature combinations supported by the network node; receive, from the UE 120, a PRACH message including a UE feature indicator in a RACH occasion associated with the PRACH configuration; and transmit, to the UE 120, an RAR message including a confirmation indication associated with the UE feature indicator. Additionally, or alternatively, the communication manager 150 may perform one or more other operations described herein.

As indicated above, FIG. 1 is provided as an example. Other examples may differ from what is described with regard to FIG. 1.

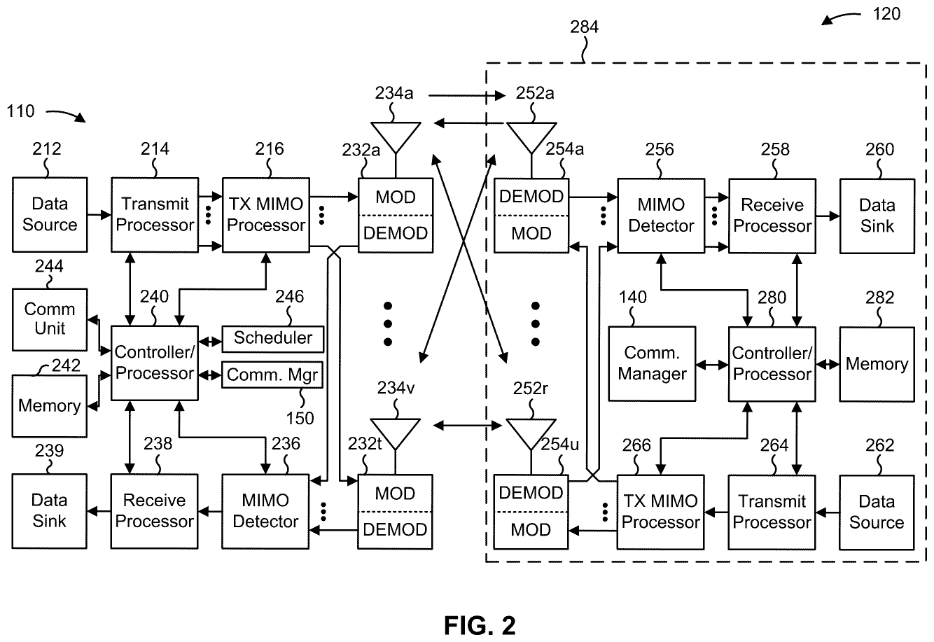

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For DL communication from the network node 110 to the UE 120, the transmit processor 214 may receive data (“DL data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a DL in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain DL signal. The modems 232a through 232t may together transmit a set of DL signals (for example, T DL signals) via the corresponding set of antennas 234.

A DL signal may include a DCI communication, a MAC control element (MAC-CE) communication, an RRC communication, a DL reference signal, or another type of DL communication. DL signals may be transmitted on a PDCCH, a PDSCH, and/or on another DL channel. A DL signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the DL resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For UL communication from the UE 120 to the network node 110, UL signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for DL or UL communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For DL communication from the network node 110 to the UE 120, the set of antennas 252 may receive the DL communications or signals from the network node 110 and may provide a set of received DL signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For UL communication from the UE 120 to the network node 110, the transmit processor 264 may receive and process data (“UL data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the UL communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an UL DMRS, an UL sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an UL signal.

The modems 254a through 254u may transmit a set of UL signals (for example, R UL signals or U UL symbols) via the corresponding set of antennas 252. An UL signal may include a UCI communication, a MAC-CE communication, an RRC communication, or another type of UL communication. UL signals may be transmitted on a PUSCH, a PUCCH, and/or another type of UL channel. An UL signal may carry one or more TBs of data. Sidelink data and control transmissions (that is, transmissions directly between two or more UEs 120) may generally use similar techniques as were described for UL data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

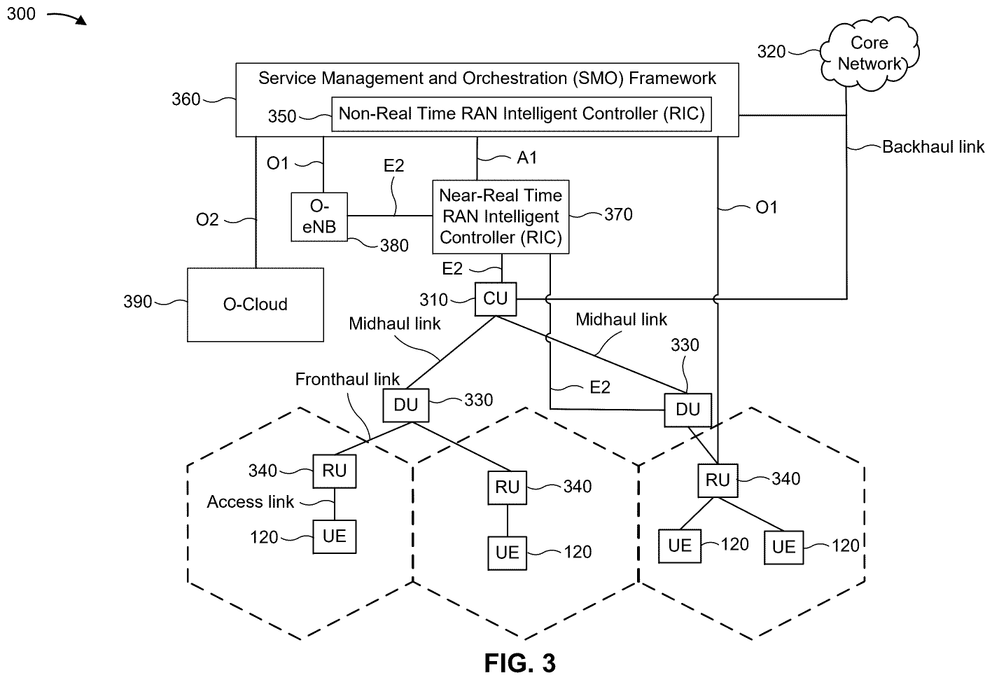

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-cNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-cNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

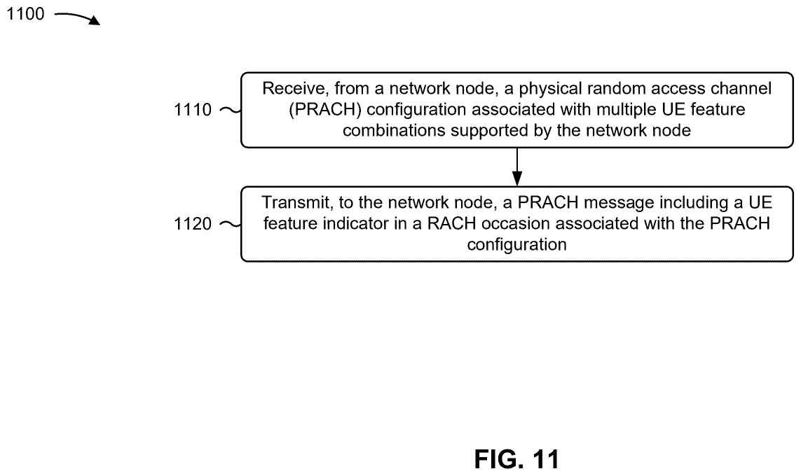

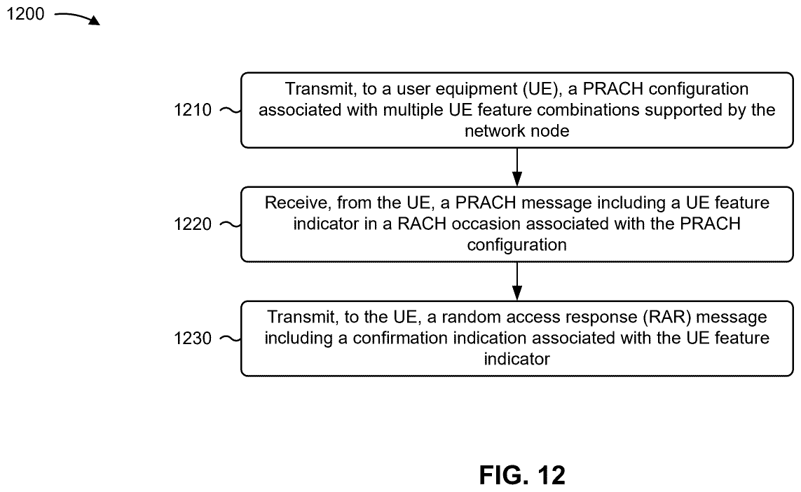

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with enhanced MSG1/MSGA transmission for early indication of UE features, as described in more detail elsewhere herein. For example, the controller/processor 240 of the network node 110, the controller/processor 280 of the UE 120, any other component(s) (or combinations of components) of FIG. 2, the CU 310, the DU 330, or the RU 340 may perform or direct operations of, for example, process 1100 of FIG. 11, process 1200 of FIG. 12, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1100 of FIG. 11, process 1200 of FIG. 12, or other processes as described herein. In some examples, executing instructions may include running the instructions, converting the instructions, compiling the instructions, and/or interpreting the instructions, among other examples.

In some aspects, the UE 120 includes means for receiving, from a network node 110, a PRACH configuration associated with multiple UE feature combinations supported by the network node 110; and/or means for transmitting, to the network node 110, a PRACH message including a UE feature indicator in a RACH occasion associated with the PRACH configuration. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE 120, a PRACH configuration associated with multiple UE feature combinations supported by the network node 110; means for receiving, from the UE 120, a PRACH message including a UE feature indicator in a RACH occasion associated with the PRACH configuration; and/or means for transmitting, to the UE 120, an RAR message including a confirmation indication associated with the feature indicator. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

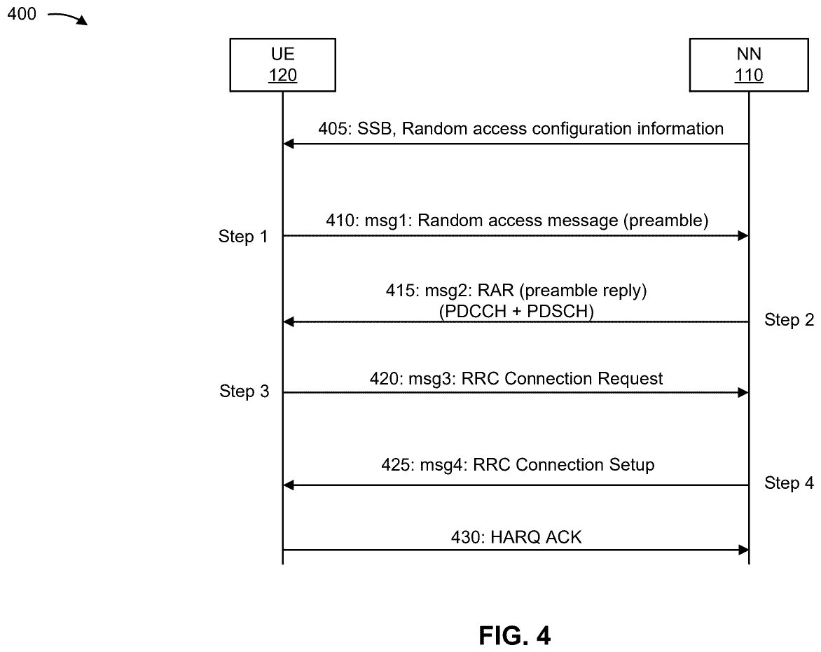

FIG. 4 is a diagram illustrating an example 400 of a four-step random access procedure, in accordance with the present disclosure. As shown in FIG. 4, a network node 110 and a UE 120 may communicate with one another to perform the four-step random access procedure.

As shown by reference number 405, the network node 110 may transmit, and the UE 120 may receive, one or more SSBs and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the random access procedure, such as one or more parameters for transmitting a random access message and/or one or more parameters for receiving an RAR. Additionally, the random access configuration may indicate separate RACH resources with dedicated RACH configurations for different UE features and/or combinations of UE features that are supported by the network node 110.

As shown by reference number 410, the UE 120 may transmit a random access message, which may include a preamble (sometimes referred to as a random access preamble, a PRACH preamble, or a random access message preamble). The message that includes the preamble may be referred to as a message 1, msg1, MSG1, a first message, or an initial message in a four-step random access procedure. The random access message may include a random access preamble identifier.

As shown by reference number 415, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC protocol data unit (PDU) of the PDSCH communication.

As shown by reference number 420, the UE 120 may transmit an RRC connection request message. The RRC connection request message may be referred to as message 3, msg3, MSG3, or a third message of a four-step random access procedure. In some aspects, the RRC connection request may include a UE identifier, UCI, and/or a PUSCH communication (e.g., an RRC connection request).

As shown by reference number 425, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. As shown by reference number 430, if the UE 120 successfully receives the RRC connection setup message, the UE 120 may transmit a hybrid automatic repeat request (HARQ) acknowledgement (ACK).

As indicated above, FIG. 4 is provided as an example. Other examples may differ from what is described with regard to FIG. 4.

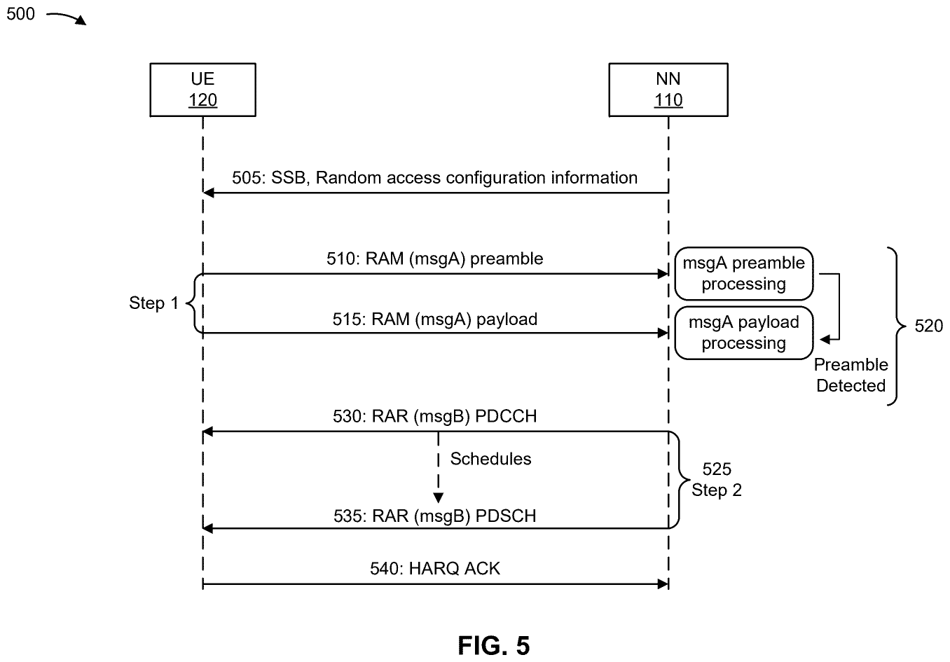

FIG. 5 is a diagram illustrating an example 500 of a two-step random access procedure, in accordance with the present disclosure. As shown in FIG. 5, a network node 110 and a UE 120 may communicate with one another to perform the two-step random access procedure.

As shown by reference number 505, the network node 110 may transmit, and the UE 120 may receive, one or more SSBs and random access configuration information. In some aspects, the random access configuration information may be transmitted in and/or indicated by system information (e.g., in one or more SIBs) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the two-step random access procedure, such as one or more parameters for transmitting a random access message and/or receiving an RAR to the random access message. Additionally, the random access configuration may indicate separate RACH resources with dedicated RACH configurations for different UE features and/or combinations of UE features that are supported by the network node 110.

As shown by reference number 510, the UE 120 may transmit, and the network node 110 may receive, a random access message preamble. As shown by reference number 515, the UE 120 may transmit, and the network node 110 may receive, a random access message payload. As shown, the UE 120 may transmit the random access message preamble and the random access message payload to the network node 110 as part of an initial (or first) step of the two-step random access procedure. In some aspects, the random access message may be referred to as message A, msgA, a first message, or an initial message in a two-step random access procedure. Furthermore, in some aspects, the random access message preamble may be referred to as a message A preamble, a msgA preamble, a preamble, or a PRACH preamble, and the random access message payload may be referred to as a message A payload, a msgA payload, or a payload. In some aspects, the random access message may include some or all of the contents of message 1 (msg1) and message 3 (msg3) of a four-step random access procedure, which is described in more detail below. For example, the random access message preamble may include some or all contents of message 1 (e.g., a PRACH preamble), and the random access message payload may include some or all contents of message 3 (e.g., a UE identifier, UCI, and/or a PUSCH transmission).

As shown by reference number 520, the network node 110 may receive the random access message preamble transmitted by the UE 120. If the network node 110 successfully receives and decodes the random access message preamble, the network node 110 may then receive and decode the random access message payload.

As shown by reference number 525, the network node 110 may transmit an RAR (sometimes referred to as an RAR message). As shown, the network node 110 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, and/or contention resolution information.

As shown by reference number 530, as part of the second step of the two-step random access procedure, the network node 110 may transmit a PDCCH communication for the RAR. The PDCCH communication may schedule a PDSCH communication that includes the RAR. For example, the PDCCH communication may indicate a resource allocation (e.g., in DCI) for the PDSCH communication.

As shown by reference number 535, as part of the second step of the two-step random access procedure, the network node 110 may transmit the PDSCH communication for the RAR, as scheduled by the PDCCH communication. The RAR may be included in a MAC PDU of the PDSCH communication. As shown by reference number 540, if the UE 120 successfully receives the RAR, the UE 120 may transmit a HARQ ACK.

As indicated above, FIG. 5 is provided as an example. Other examples may differ from what is described with regard to FIG. 5.

In a wireless network, a network node may provide different random access configurations to support RACH features associated with different use cases. For example, a network node may generally configure a four-step RACH procedure (e.g., as described with reference to FIG. 4) as a default or legacy RACH feature, and the network node may further configure a two-step RACH procedure (e.g., as described with reference to FIG. 5) to reduce latency and control signaling overhead by having a single round-trip cycle between the UE and the network node (as opposed to two round-trip cycles in the case of a four-step RACH procedure). Additionally, or alternatively, the network node may provide one or more random access configurations to support RACH features such as SDT to transfer small data payloads to and/or from the UE during the RACH procedure, RAN slices or slice groups (e.g., a network architecture model in which logically distinct network slices using common network infrastructure operate as isolated end-to-end networks customized to satisfy different service requirements), enhanced coverage in wireless environments with poor network conditions (e.g., using multiple msg3 repetitions), RedCap UEs to improve access by UEs that may have a reduced feature set relative to a premium UE, and/or preamble groupings to indicate different preamble sequences to be selected depending on the size of uplink data to be sent by a UE and/or network conditions associated with the UE, among other examples.

In existing wireless networks, each RACH feature supported by a network node can be configured with separate PRACH resources (e.g., RACH occasions (ROs) and/or preambles) that are dedicated to the RACH feature. For example, the network node may configure a first set of PRACH resources (e.g., a first set of ROs and/or a first set preambles) for a coverage enhancement RACH feature and may configure a second set of PRACH resources (e.g., a second set of ROs and/or a second set preambles) for a RedCap RACH feature. In this way, a UE may initiate a RACH procedure using the dedicated PRACH resources in order to request special handling associated with the corresponding RACH feature or use case from the network. However, providing a separate PRACH configuration for each RACH feature generally results in high signaling overhead and inefficient resource utilization. For example, if a network node that supports N different RACH features were to provide a separate dedicated PRACH configuration for each possible combination of RACH features, the network node would have to configure 2^{N} RACH partitions, where one RACH partition may generally correspond to one set of dedicated PRACH resources to support a particular combination of one or more RACH features. Furthermore, separate PRACH configurations may result in a hard partition of PRACH resources, which may be inefficient because PRACH resource configurations are typically advertised or otherwise indicated in system information, which is usually updated infrequently. As a result, the network node may be unable to closely track access loads (e.g., the number of UEs that are initiating a RACH procedure associated with a given set of RACH features) and make frequent updates to PRACH configurations based on the access loads, whereby the hard partition of PRACH resources may result in inefficient resource utilization (sometimes referred to as trunking gain). Furthermore, various elements in the separate RACH configurations may be redundant (e.g., the same across different RACH configurations), which results in high signaling overhead.

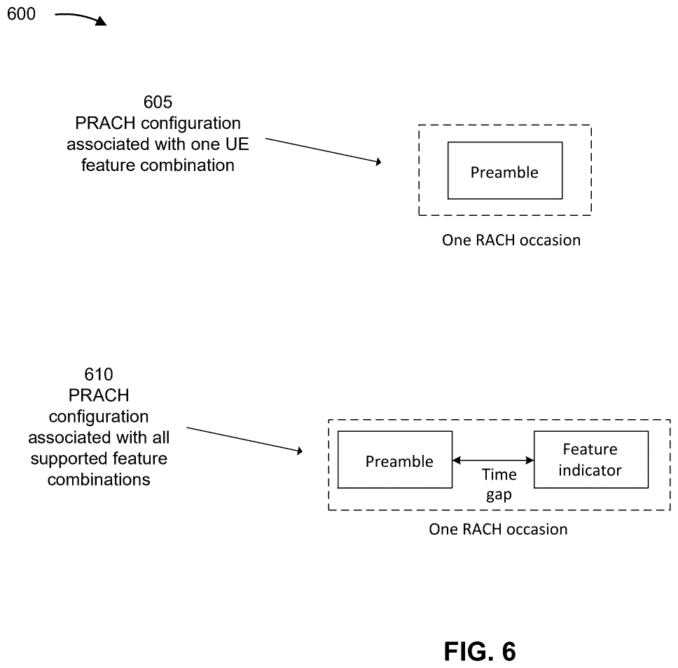

FIG. 6 is a diagram illustrating an example 600 associated with a PRACH configuration associated with different UE feature combinations, in accordance with the present disclosure.

As shown in FIG. 6, reference number 605 corresponds to an example legacy PRACH configuration associated with one UE feature combination in one RACH occasion. For example, the UE selects a preamble from a set of preambles defined by the network node for a UE feature combination associated with the UE, and the UE selects a random sequence number for the preamble. The UE transmits the preamble on the PRACH in one RACH occasion. A network node may then receive the preamble transmitted from the UE, enabling the network node to identify the UE and the feature combination associated with the UE (e.g., based on the RACH occasion in which the preamble is transmitted) and continue the RACH procedure.

In contrast, reference number 610 corresponds to a PRACH configuration associated with multiple UE feature combinations in one RACH occasion, according to some aspects described herein. For example, as shown, the PRACH configuration may include a preamble and a feature indicator in one RACH occasion.

In some aspects, the preamble may be a preamble sequence used in legacy RACH preamble transmissions (e.g., a Zadoff-Chu sequence or any other pseudo-random sequence), where the UE may select the preamble from a set of preambles defined by the network node in order to identify the UE and continue the RACH procedure.

In some aspects, the PRACH message may further include a feature indicator associated with the UE. By associating all supported UE feature combinations with a single PRACH configuration and including the UE feature indicator in the PRACH message, the network node does not need to indicate a dedicated resource configuration (e.g., a dedicated RACH resource allocation) for each feasible combination of UE features. Rather, the network node may advertise the supported feature combinations in random access configuration information, and the UE may use the feature indicator to indicate the feature or combination of features that match or most closely match the feature(s) associated with the UE.

In the context of a four-step RACH procedure, the feature indicator may include a pseudo-random sequence and/or a sequence selected from a set of legacy sequences (e.g., Zadoff-Chu sequences). Additionally, system information (e.g., remaining minimum system information (RMSI), also known as SIB1) of the network node may communicate a mapping between configured sequences and indexes associated with different feature indicators. For example, the feature indicator of the UE may include a sequence mapped to an index to communicate a feature or feature combination that matches or most closely matches the feature(s) associated with the UE to the network node. In some aspects, the preamble sequence selected by the UE and the sequence for the feature indicator may be independent and/or decoupled from each other. In the context of a two-step RACH procedure, the feature indicator may be a MAC-CE included in a PUSCH payload of MSGA or may be sent as a UCI multiplexed in the MSGA PUSCH payload.

As described herein, as the number of UE features increases, the RACH procedure communications become more complicated and resource intensive, because a network node may configure dedicated RACH resources and configurations for each new supported UE feature or combination of UE features. Accordingly, enabling a UE to signal the feature combination that triggers a RACH via a MSG1 or MSGA over a single PRACH configuration improves RACH resource allocation at the network node and simplifies the RACH procedure between a network node and a UE.

As indicated above, FIG. 6 is provided as an example. Other examples may differ from what is described with respect to FIG. 6.

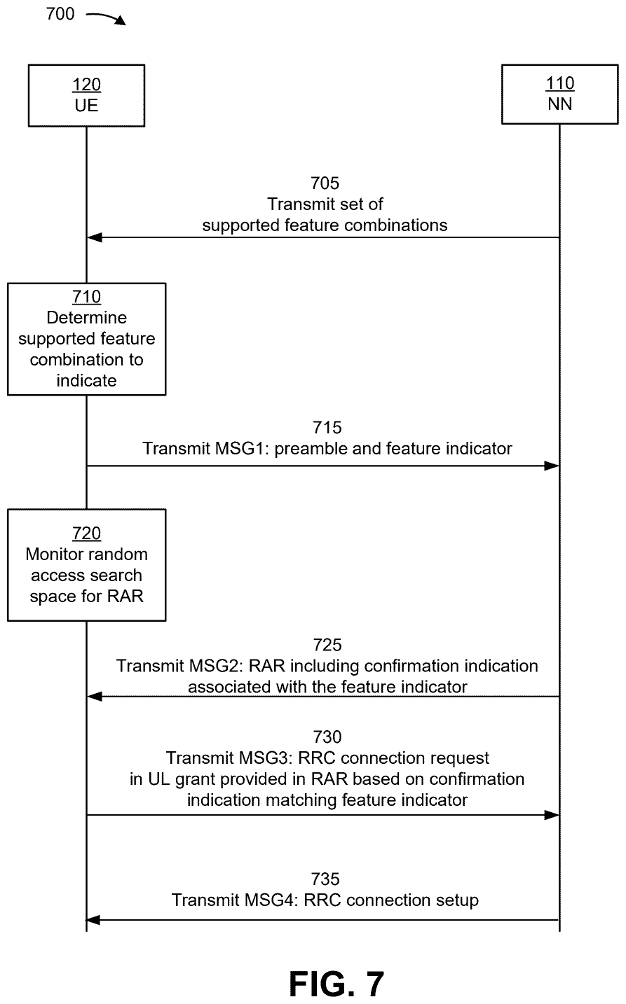

FIG. 7 is a diagram of an example 700 associated with enhanced MSG1 transmissions for early indication of UE 120 features in a four-step RACH procedure, in accordance with the present disclosure. As shown in FIG. 7, a network node 110 may communicate with a UE (e.g., UE 120). In some aspects, the network node 110 and the UE 120 may be part of a wireless network (e.g., wireless network 100). The RACH procedure may be part of a reconnection of communications between the UE 120 and the network node 110 and/or used for initial access.

As shown by reference number 705, the network node 110 may transmit, and the UE 120 may receive, configuration information indicating at least one set of feature combinations supported by the network node 110. In some aspects, the UE 120 may receive the configuration information via one or more of system information (e.g., an SSB, a master information block (MIB), and/or an SIB, such as SIB1, among other examples), RRC signaling, one or MAC-CEs, and/or DCI, among other examples. In some aspects, the configuration information may be transmitted as random access configuration information, which includes parameters (e.g., a PRACH configuration) to be used in the RACH procedure, including a set of preambles in addition to the at least one feature and/or to the at least one set of feature combinations supported by the network node 110.

As shown by reference number 710, the UE 120 may determine the feature combination transmitted by the network node 110 that matches or best matches the feature combination associated with the UE. For example, the features included in feature combinations supported by the network node 110 may include RedCap, network slicing, CovEnh, SDT, or the like. For example, where a UE 120 is a RedCap UE, the feature combination that matches or best matches may be a RedCap feature. Similarly, for example, where a UE 120 is a RedCap UE 120 that only supports a four-step RACH procedure and the feature combination includes a RedCap feature that supports only two-step RACH (e.g., there is not a match), this two-step RACH RedCap feature may be the feature that is utilized as being the best match.

As shown by reference number 715, the UE 120 may transmit, to the network node 110, a MSG1 that includes a preamble and the feature indicator selected by the UE 120. The preamble may be selected (e.g., randomly) from a set of sequences provided in the RACH configuration. In some aspects, the feature indicator may be a pseudo-random sequence or may be selected from a set of legacy sequences (e.g., Zadoff-Chu sequences).

In some aspects, the configuration information provided by the network node 110 may include a mapping between a configured sequence and an index associated with the feature indicator. For example, the feature indicator of the UE 120 may include an index to communicate a selected feature combination to the network node 110. As a result, the preamble sequence selected by the UE 120 and the sequence for the feature indicator may be independent and may be uncoupled from one another. Accordingly, there may be no coupling or dependence between the preamble sequence selected by the UE 120 and the sequence for the feature indicator.

As shown by reference number 720, the UE 120 may monitor a random access search space for an RAR message (e.g., a message 2, also referred to as msg2 or MSG2) from the network node.

As shown by reference number 725, the network node 110 may transmit, to the UE 120, a MSG2 with an RAR including a confirmation indication associated with the feature indicator transmitted to the network node 110 in MSG1. In some aspects, the MSG2 may be scrambled by a temporary identifier, which may include a radio network temporary identifier (RNTI) or a random access-RNTI (RA-RNTI). In some aspects, if the UE 120 does not receive the MSG2 during a period of time (e.g., an RAR window), the UE 120 considers the MSG1 TX as failed, and the UE 120 may retransmit the MSG1.

As shown by reference number 730, if the UE 120 receives a MSG2 from the network node 110, the UE 120 may confirm whether the MSG2 includes a preamble and feature indicator that matches the preamble and feature indicator transmitted in MSG1. If the preamble and feature indicator of MSG2 match the preamble and feature indicator transmitted in MSG1, the UE 120 transmits a MSG3 to the network node 110. In some aspects, the MSG3 may be an RRC connection request sent using an UL grant provided in the RAR of MSG2. In some aspects, the UE 120 may further confirm the MSG2 via the RA-RNTI or RNTI included with MSG2. For example, the UE 120 may determine whether the MSG2 is scrambled by the RA-RNTI associated with the UE 120, and the UE 120 may transmit the MSG3 to the network node based on the RA-RNTI used to scramble the MSG2 matching the RA-RNTI associated with the UE 120.

As shown by reference number 735, after the network node 110 receives the MSG3, the network node 110 may transmit a MSG4 including an RRC connection setup for the UE 120, where the UE 120 and network node 110 may further establish a connection.

As described herein, as the number of UE features increases, RACH procedure communications may become more complicated and resource intensive, in cases where a network node 110 configures dedicated RACH resources and configurations for each new supported UE feature. Accordingly, enabling a UE 120 to signal the feature combination that triggers a RACH via a MSG1 over a single PRACH configuration and enabling the network node 110 to confirm the selected feature combination, according to some aspects described herein, improves RACH resource allocation, increases efficiency of RACH resource usage, and/or simplifies the RACH procedure between a network node 110 and a UE 120.

As indicated above, FIG. 7 is provided as an example. Other examples may differ from what is described with respect to FIG. 7.

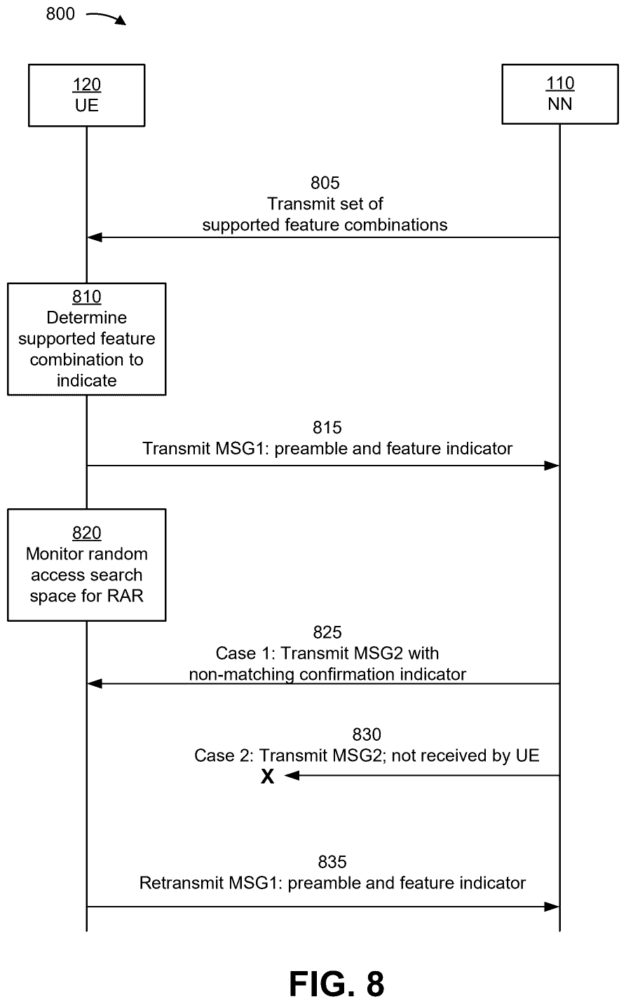

FIG. 8 is a diagram of an example 800 associated with aspects of enhanced MSG1 transmissions for early indication of UE features in a four-step RACH procedure, in accordance with the present disclosure. As shown in FIG. 8, a network node 110 may communicate with a UE 120. In some aspects, the network node 110 and the UE 120 may be part of a wireless network (e.g., wireless network 100). The RACH procedure may be part of a reconnection of communications between the UE 120 and the network node 110 and/or used for initial access.

As shown by reference number 805, the network node 110 may transmit, and the UE 120 may receive, configuration information indicating at least one set of feature combinations supported by the network node 110. In some aspects, the UE 120 may receive the configuration information via one or more of system information (e.g., an SSB, an MIB and/or an SIB, such as SIB1, among other examples), RRC signaling, one or MAC-CEs, and/or DCI, among other examples. In some aspects, the configuration information may be transmitted as random access configuration information, which includes parameters (e.g., a PRACH configuration) to be used in the RACH procedure, including a set of preambles in addition to the at least one feature and/or to the at least one set of feature combinations supported by the network node 110.

As shown by reference number 810, the UE 120 may determine the feature combination transmitted by the network node 110 that matches or best matches the feature combination associated with the UE 120. For example, the features included in feature combinations supported by the network node 110 may include RedCap, network slicing, CovEnh, SDT, or the like. For example, where a UE 120 is a RedCap UE, the feature combination that matches or best matches may be a RedCap feature. Similarly, for example, where a UE 120 is a RedCap UE 120 that only supports a four-step RACH procedure and the feature combination includes a RedCap feature that supports only two-step RACH (e.g., there is not a match), this two-step RACH RedCap feature may be the feature that is utilized as being the best match.

As shown by reference number 815, the UE 120 may transmit, to the network node 110, a MSG1 that includes a preamble and the feature indicator selected by the UE 120. The preamble may be selected (e.g., randomly) from a set of sequences provided in the RACH configuration. In some aspects, the feature indicator may be a pseudo-random sequence or may be a set of legacy sequences (e.g., Zadoff-Chu sequences).

In some aspects, the configuration information provided by the network node 110 may include a mapping between a configured sequence and an index associated with the feature indicator. For example, the feature indicator of the UE 120 may include an index to communicate a selected feature combination to the network. As a result, the preamble sequence selected by the UE 120 and the sequence for the feature indicator may be independent and may be uncoupled of one another. Accordingly, there may be no coupling or dependence between the preamble sequence selected by the UE 120 and the sequence for the feature indicator.

As shown by reference number 820, the UE 120 may monitor a random access search space for an RAR message (e.g., a message 2, also referred to as msg2 or MSG2) from the network node 110.

As shown by reference number 825, in a first scenario (shown as Case 1), the UE 120 may receive a MSG2 transmitted from the network node 110. However, in the first scenario, the confirmation indicator in MSG2 does not match the confirmation indicator transmitted from the UE 120 to the network node 110 in MSG1. Accordingly, the UE 120 considers the MSG1 TX as failed. For example, the UE 120 may consider the MSG1 TX as failed based on the RA-RNTI used to scramble the MSG2 failing to match the RA-RNTI associated with the UE 120.

Similarly, and as shown by reference number 830, in a second scenario scenario (shown as Case 2), the UE 120 may not receive a MSG2 from the network node 110. For example, in some aspects, the UE 120 does not receive the MSG2 during a defined time period (e.g., an RAR window). As a result, the UE 120 considers the MSG1 TX as failed.

As shown by reference number 835, when the UE 120 considers a MSG1 TX as failed (e.g., in Case 1 or Case 2), the UE 120 may retransmit the MSG1 to the network node 110, where the UE 120 retransmits the preamble and feature indicator. In some aspects, the UE 120 may reselect a preamble to transmit, but the UE 120 retransmits the feature indicator from the previous MSG1.

As described herein, enabling a UE 120 to signal the feature combination that triggers a RACH via a MSG1 over a single PRACH configuration and enabling the network node 110 to confirm the selected feature combination, according to some aspects described herein, improves RACH resource allocation, increases efficiency of RACH resource usage, and/or simplifies the RACH procedure between a network node 110 and a UE 120. When a UE 120 fails to receive a confirmation indicator from the network node 110 or receives a confirmation indicator that includes a non-matching feature indicator, the RACH process may be delayed or incomplete, thus hindering the benefits of providing the feature indicator. Accordingly, enabling the UE 120 to monitor and retransmit, when necessary, the MSG1 can ensure that the correct feature indicator is received and acknowledged by the network node 110 prior to the UE transmitting a MSG3 to the network node 110.

As indicated above, FIG. 8 is provided as an example. Other examples may differ from what is described with respect to FIG. 8.

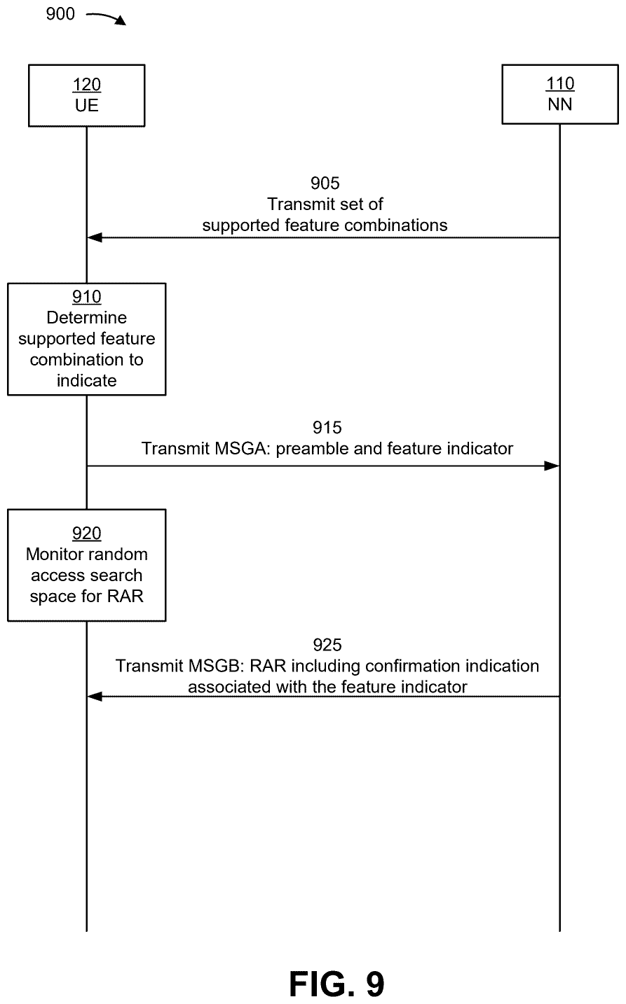

FIG. 9 is a diagram of an example 900 associated with enhanced MSGA transmissions for early indication of UE 120 features in a two-step RACH procedure, in accordance with the present disclosure. As shown in FIG. 9, a network node 110 may communicate with a UE 120. In some aspects, the network node 110 and the UE 120 may be part of a wireless network (e.g., wireless network 100). The RACH procedure may be part of a reconnection of communications between the UE 120 and the network node 110 and/or used for initial access.

As shown by reference number 905, the network node 110 may transmit, and the UE 120 may receive, configuration information indicating at least one set of feature combinations supported by the network node 110. In some aspects, the UE may receive the configuration information via one or more of system information (e.g., an SSB, an MIB and/or an SIB, such as SIB1, among other examples), RRC signaling, one or MAC-CEs, and/or DCI, among other examples. In some aspects, the configuration information may be transmitted as random access configuration information, which includes parameters (e.g., a PRACH configuration) to be used in the RACH procedure, including a set of preambles in addition to the at least one feature and/or to the at least one set of feature combinations supported by the network node 110.

As shown by reference number 910, the UE 120 may determine the feature combination transmitted by the network node that matches or best matches the feature combination associated with the UE 120. For example, the features included in a feature combination supported by the network node 110 may include RedCap, network slicing, CovEnh, SDT, or the like. For example, where a UE 120 is a RedCap UE, the feature combination that matches or best matches may be a RedCap feature. Similarly, for example, where a UE 120 is a RedCap UE 120 that only supports a four-step RACH procedure and the feature combination includes a RedCap feature that supports only two-step RACH (e.g., there is not a match), this two-step RACH RedCap feature may be the feature that is utilized as being the best match.

As shown by reference number 915, the UE 120 may transmit, to the network node 110, a MSGA that includes a preamble and the feature indicator selected by the UE 120. The preamble may be selected (e.g., randomly) from a set of sequences provided in the RACH configuration. In some aspects, the feature indicator may be a MAC-CE sent in the PUSCH payload of the MSGA.

In some aspects, the configuration information provided by the network node 110 may include a mapping between a configured sequence and an index associated with the feature indicator. For example, the feature indicator of the UE 120 may include an index to communicate a selected feature combination to the network. As a result, the preamble sequence selected by the UE 120 and the sequence for the feature indicator may be independent and may be uncoupled of one another. Accordingly, there may be no coupling or dependence between the preamble sequence selected by the UE 120 and the sequence for the feature indicator.

As shown by reference number 920, the UE 120 may monitor a random access search space for an RAR message (e.g., a message B, also referred to as msgB or MSGB) from the network node 110.

As shown by reference number 925, the network node 110 may transmit, to the UE 120, a MSGB with an RAR including a confirmation indication associated with the feature indicator transmitted to the network node 110 in MSGA. In some aspects, the MSGB may be scrambled by a temporary identifier, which may include an RNTI or an RA-RNTI. In some aspects, if the UE 120 does not receive the MSGB during a period of time (e.g., an RAR window), the UE 120 considers the MSGA TX as failed, and the UE 120 may retransmit the MSGA.

In some aspects, if the UE 120 receives a MSGB from the network node 110, the UE 120 may confirm that the MSGB includes a preamble and feature indicator that matches the preamble and feature indicator transmitted in MSGA, the UE 120 may proceed to establishing an RRC connection setup between the network node 110 and the UE 120. In some aspects, the UE may further confirm the MSGB via the RA-RNTI or RNTI included with MSGB. For example, the UE may determine whether the MSGB is scrambled by the RA-RNTI associated with the UE, and the UE may continue the RACH procedure based on the RA-RNTI used to scramble the MSGB matching the RA-RNTI associated with the UE.

As described herein, as the number of UE 120 features increases, RACH procedure communications may become more complicated and resource intensive, in cases where a network node 110 configures dedicated RACH resources and configurations for each new supported UE 120 feature. Accordingly, enabling a UE 120 to signal the feature combination that triggers a RACH via a MSGA over a single PRACH configuration and enabling the network node 110 to confirm the selected feature combination, according to some aspects described herein, improves RACH resource allocation, increases efficiency of RACH resource usage, and simplifies the RACH procedure between a network node 110 and a UE 120.

As indicated above, FIG. 9 is provided as an example. Other examples may differ from what is described with respect to FIG. 9.

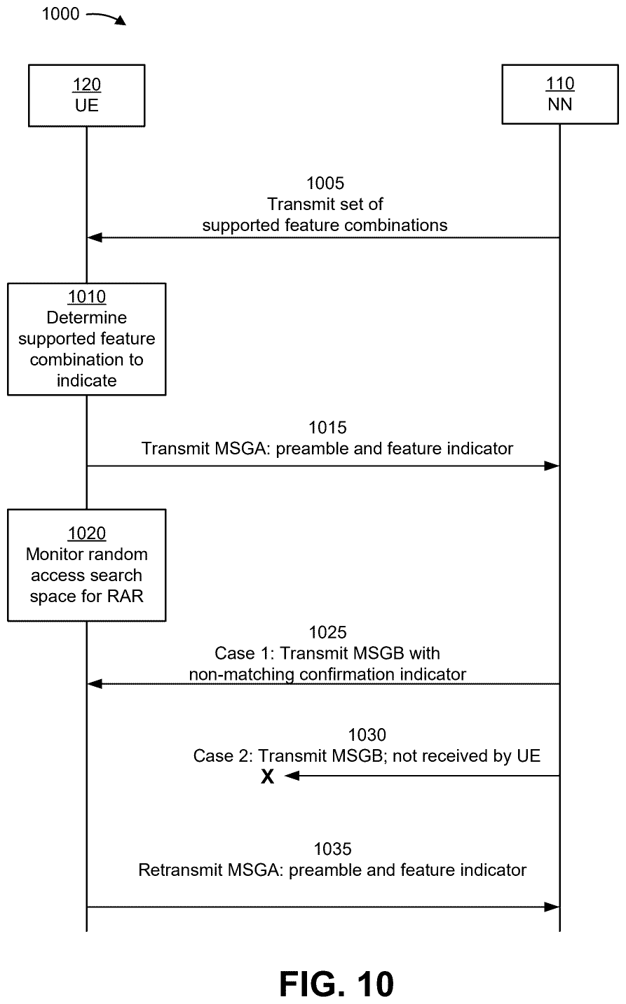

FIG. 10 is a diagram of an example 1000 associated with aspects of enhanced MSGA transmissions for early indication of UE 120 features in a two-step RACH procedure, in accordance with the present disclosure. As shown in FIG. 10, a network node 110 may communicate with a UE 120. In some aspects, the network node 110 and the UE 120 may be part of a wireless network (e.g., wireless network 100). The RACH procedure may be part of a reconnection of communications between the UE 120 and the network node 110 and/or used for initial access.

As shown by reference number 1005, the network node 110 may transmit, and the UE 120 may receive, configuration information indicating at least one set of feature combinations supported by the network node 110. In some aspects, the UE 120 may receive the configuration information via one or more of system information (e.g., an SSB, an MIB and/or an SIB, such as SIB1, among other examples), RRC signaling, one or MAC-CEs, and/or DCI, among other examples. In some aspects, the configuration information may be transmitted as random access configuration information, which includes parameters (e.g., a PRACH configuration) to be used in the RACH procedure, including a set of preambles in addition to the at least one feature and/or to the at least one set of feature combinations supported by the network node 110.

As shown by reference number 1010, the UE 120 may determine the feature combination transmitted by the network node 110 that matches or best matches the feature combination associated with the UE 120. For example, the features included in feature combinations supported by the network node 110 may include RedCap, network slicing, CovEnh, SDT, or the like. For example, where a UE 120 is a RedCap UE, the feature combination that matches or best matches may be a RedCap feature. Similarly, for example, where a UE 120 is a RedCap UE 120 that only supports a four-step RACH procedure and the feature combination includes a RedCap feature that supports only two-step RACH (e.g., there is not a match), this two-step RACH RedCap feature may be the feature that is utilized as being the best match.

As shown by reference number 1015, the UE 120 may transmit, to the network node 110, a MSGA that includes a preamble and the feature indicator selected by the UE 120. The preamble may be selected (e.g., randomly) from a set of sequences provided in the RACH configuration. In some aspects, the feature indicator may be a MAC-CE sent in the PUSCH payload of the MSGA.

In some aspects, the configuration information provided by the network node 110 may include a mapping between a configured sequence and an index associated with the feature indicator. For example, the feature indicator of the UE 120 may include an index to communicate a selected feature combination to the network. As a result, the preamble sequence selected by the UE 120 and the sequence for the feature indicator may be independent and may be uncoupled of one another. Accordingly, there may be no coupling or dependence between the preamble sequence selected by the UE 120 and the sequence for the feature indicator.

As shown by reference number 1020, the UE 120 may monitor a random access search space for an RAR message (e.g., a message B, also referred to as msgB or MSGB) from the network node 110.

As shown by reference number 1025, in a first scenario (shown as Case 1), the UE 120 may receive a MSGB transmitted from the network node 110. However, in the first scenario, the confirmation indicator in MSGB does not match the confirmation indicator transmitted from the UE 120 to the network node 110 in MSGA. Accordingly, the UE 120 considers the MSGA TX as failed. For example, the UE 120 may consider the MSGA TX as failed based on the RA-RNTI used to scramble the MSGB failing to match the RA-RNTI associated with the UE 120

Similarly, and as shown by reference number 1030, in a second scenario (shown as Case 2), the UE 120 may not receive a MSGB from the network node 110. For example, in some aspects, the UE 120 does not receive the MSGB during a defined time period (e.g., an RAR window). As a result, the UE 120 considers the MSGA TX as failed. For example, the UE 120 may consider the MSGA TX as failed based on the RA-RNTI used to scramble the MSGA failing to match the RA-RNTI associated with the UE 120

As shown by reference number 1035, when the UE 120 considers a MSGA TX as failed (e.g., in Case 1 or Case 2), the UE 120 may retransmit the MSGA to the network node 110, where the UE 120 retransmits the preamble and feature indicator. In some aspects, the UE 120 may reselect a preamble to transmit, but the UE 120 retransmits the feature indicator from the previous MSG1.

As described herein, enabling a UE 120 to signal the feature combination that triggers a RACH via a MSGA over a single PRACH configuration and enabling the network node 110 to confirm the selected feature combination, according to some aspects described herein, improves RACH resource allocation, increases efficiency of RACH resource usage, and/or simplifies the RACH procedure between a network node 110 and a UE 120. When a UE 120 fails to receive a confirmation indicator from the network node 110 or receives a confirmation indicator that includes a non-matching feature indicator, the RACH process may be delayed or incomplete, thus hindering the benefits of providing the feature indicator. Accordingly, enabling the UE 120 to monitor and retransmit, when necessary, the MSGA may ensure that the correct feature indicator is received and acknowledged by the network node 110 prior to proceeding with an RRC configuration between the network node 110 and the UE 120.

As indicated above, FIG. 10 is provided as an example. Other examples may differ from what is described with respect to FIG. 10.

FIG. 11 is a diagram illustrating an example process 1100 performed, for example, at a UE or an apparatus of a UE, in accordance with the present disclosure. Example process 1100 is an example where the apparatus or the UE (e.g., UE 120) performs operations associated with enhanced MSG1/MSGA transmission for early indication of UE features.

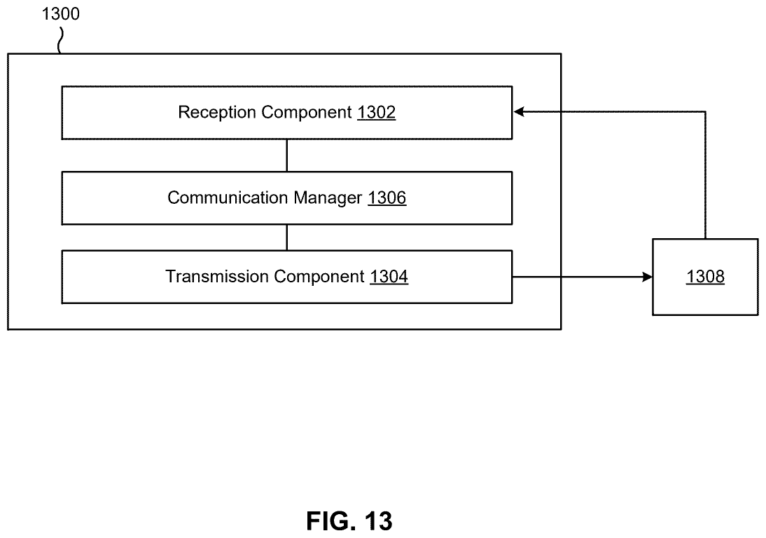

As shown in FIG. 11, in some aspects, process 1100 may include receiving, from a network node, a PRACH configuration associated with multiple UE feature combinations supported by the network node (block 1110). For example, the UE (e.g., using reception component 1302 and/or communication manager 1306, depicted in FIG. 13) may receive, from a network node, a PRACH configuration associated with multiple UE feature combinations supported by the network node, as described above.

As further shown in FIG. 11, in some aspects, process 1100 may include transmitting, to the network node, a PRACH message including a UE feature indicator in a RACH occasion associated with the PRACH configuration (block 1120). For example, the UE (e.g., using transmission component 1304 and/or communication manager 1306, depicted in FIG. 13) may transmit, to the network node, a PRACH message including a UE feature indicator in a RACH occasion associated with the PRACH configuration, as described above.

Process 1100 may include additional aspects, such as any single aspect or any combination of aspects described below and/or in connection with one or more other processes described elsewhere herein.

In a first aspect, process 1100 includes monitoring at least one random access search space for an RAR message including a confirmation indication associated with the UE feature indicator.

In a second aspect, alone or in combination with the first aspect, process 1100 includes retransmitting, to the network node, the PRACH message in accordance with not receiving the RAR message within an RAR window.

In a third aspect, alone or in combination with one or more of the first and second aspects, process 1100 includes receiving, from the network node, the RAR message including the confirmation indication associated with the UE feature indicator, and retransmitting, to the network node, the PRACH message based on the confirmation indication failing to match the UE feature indicator.

In a fourth aspect, alone or in combination with one or more of the first through third aspects, process 1100 includes receiving, from the network node, the RAR message including the confirmation indication associated with the UE feature indicator, and transmitting, to the network node, a PUSCH payload in an uplink grant indicated in the RAR message based on the confirmation indication matching the UE feature indicator.

In a fifth aspect, alone or in combination with one or more of the first through fourth aspects, process 1100 includes receiving, from the network node, an indication of the multiple UE feature combinations supported by the network node.

In a sixth aspect, alone or in combination with one or more of the first through fifth aspects, the indication of the multiple UE feature combinations is carried in a system information block.

In a seventh aspect, alone or in combination with one or more of the first through sixth aspects, the indication of the multiple UE feature combinations indicates a mapping between each of the multiple UE feature combinations and an index associated with the UE feature indicator.

In an eighth aspect, alone or in combination with one or more of the first through seventh aspects, the PRACH message further includes a preamble associated with a first sequence, and the first sequence is independent of a second sequence associated with the UE feature indicator.

In a ninth aspect, alone or in combination with one or more of the first through eighth aspects, the UE feature indicator is a MAC-CE included in a PUSCH payload.

In a tenth aspect, alone or in combination with one or more of the first through ninth aspects, the UE feature indicator is a UCI message multiplexed in a PUSCH payload.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network node or an apparatus of a network node, in accordance with the present disclosure. Example process 1200 is an example where the apparatus or the network node (e.g., network node 110) performs operations associated with enhanced MSG1/MSGA transmission for early indication of UE features.

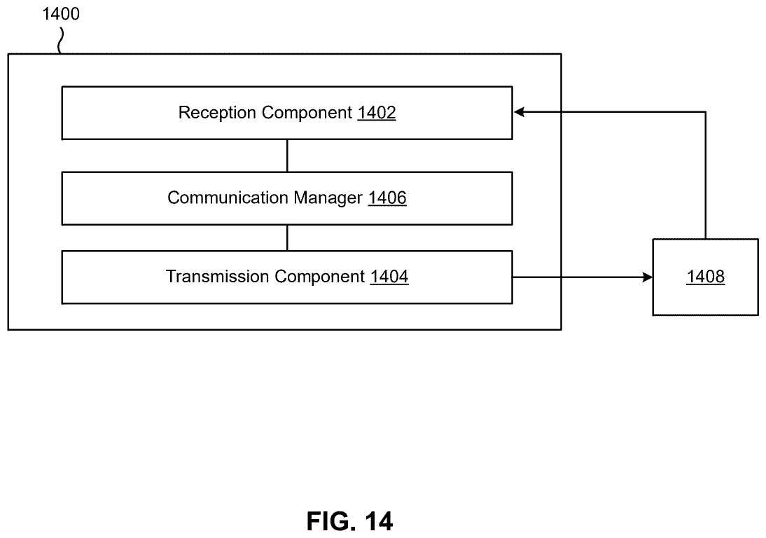

As shown in FIG. 12, in some aspects, process 1200 may include transmitting, to a UE, a PRACH configuration associated with multiple UE feature combinations supported by the network node (block 1210). For example, the network node (e.g., using transmission component 1404 and/or communication manager 1406, depicted in FIG. 14) may transmit, to a UE, a PRACH configuration associated with multiple UE feature combinations supported by the network node, as described above.

As further shown in FIG. 12, in some aspects, process 1200 may include receiving, from the UE, a PRACH message including a UE feature indicator in a RACH occasion associated with the PRACH configuration (block 1220). For example, the network node (e.g., using reception component 1402 and/or communication manager 1406, depicted in FIG. 14) may receive, from the UE, a PRACH message including a UE feature indicator in a RACH occasion associated with the PRACH configuration, as described above.

As further shown in FIG. 12, in some aspects, process 1200 may include transmitting, to the UE, an RAR message including a confirmation indication associated with the UE feature indicator (block 1230). For example, the network node (e.g., using transmission component 1404 and/or communication manager 1406, depicted in FIG. 14) may transmit, to the UE, an RAR message including a confirmation indication associated with the UE feature indicator, as described above.

Process 1200 may include additional aspects, such as any single aspect or any combination of aspects described below and/or in connection with one or more other processes described elsewhere herein.

In a first aspect, process 1200 includes receiving, from the UE, a retransmission of the PRACH configuration in accordance with the UE not receiving the RAR message within an RAR window.

In a second aspect, alone or in combination with the first aspect, process 1200 includes receiving, from the UE, a retransmission of the PRACH message based on the UE determining that the confirmation indication fails to match the UE feature indicator.

In a third aspect, alone or in combination with one or more of the first and second aspects, process 1200 includes receiving, from the UE, a PUSCH payload in an uplink grant indicated in the RAR message based on the confirmation indication matching the UE feature indicator.

In a fourth aspect, alone or in combination with one or more of the first through third aspects, process 1200 includes transmitting, to the UE, an indication of the multiple UE feature combinations supported by the network node.

In a fifth aspect, alone or in combination with one or more of the first through fourth aspects, the indication of the multiple UE feature combinations is carried in a system information block.

In a sixth aspect, alone or in combination with one or more of the first through fifth aspects, the indication of the multiple UE feature combinations indicates a mapping between each of the multiple UE feature combinations and an index associated with the UE feature indicator.

In a seventh aspect, alone or in combination with one or more of the first through sixth aspects, the PRACH message further includes a preamble associated with a first sequence, and the first sequence is independent of a second sequence associated with the UE feature indicator.

In an eighth aspect, alone or in combination with one or more of the first through seventh aspects, the UE feature indicator is a MAC-CE included in a PUSCH payload.

In a ninth aspect, alone or in combination with one or more of the first through eighth aspects, the UE feature indicator is a UCI message multiplexed in a PUSCH payload.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 6-10. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the UE described in connection with FIG. 1 and FIG. 2. Additionally, or alternatively, one or more components shown in FIG. 13 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive, from a network node, a PRACH configuration associated with multiple UE feature combinations supported by the network node. The transmission component 1304 may transmit, to the network node, a PRACH message including a UE feature indicator in a RACH occasion associated with the PRACH configuration.

The communication manager 1306 may monitor at least one random access search space for an RAR message including a confirmation indication associated with the UE feature indicator. The transmission component 1304 may retransmit, to the network node, the PRACH message in accordance with not receiving the RAR message within an RAR window.

The reception component 1302 may receive, from the network node, the RAR message including the confirmation indication associated with the UE feature indicator. The transmission component 1304 may retransmit, to the network node, the PRACH message based on the confirmation indication failing to match the UE feature indicator.

The reception component 1302 may receive, from the network node, the RAR message including the confirmation indication associated with the UE feature indicator. The transmission component 1304 may transmit, to the network node, a PUSCH payload in an uplink grant indicated in the RAR message based on the confirmation indication matching the UE feature indicator.

The reception component 1302 may receive, from the network node, an indication of the multiple UE feature combinations supported by the network node.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 6-10. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the network node described in connection with FIG. 1 and FIG. 2. Additionally, or alternatively, one or more components shown in FIG. 14 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1402 and/or the transmission component 1404 may include or may be included in a network interface. The network interface may be configured to obtain and/or output signals for the apparatus 1400 via one or more communications links, such as a backhaul link, a midhaul link, and/or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1404 may be co-located with the reception component 1402 in one or more transceivers.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The transmission component 1404 may transmit, to a UE, a PRACH configuration associated with multiple UE feature combinations supported by the network node. The reception component 1402 may receive, from the UE, a PRACH message including a UE feature indicator in a RACH occasion associated with the PRACH configuration. The transmission component 1404 may transmit, to the UE, an RAR message including a confirmation indication associated with the UE feature indicator.

The reception component 1402 may receive, from the UE, a retransmission of the PRACH configuration in accordance with the UE not receiving the RAR message within an RAR window.

The reception component 1402 may receive, from the UE, a retransmission of the PRACH message based on the UE determining that the confirmation indication fails to match the UE feature indicator.

The reception component 1402 may receive, from the UE, a PUSCH payload in an uplink grant indicated in the RAR message based on the confirmation indication matching the UE feature indicator.

The transmission component 1404 may transmit, to the UE, an indication of the multiple UE feature combinations supported by the network node.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: receiving, from a network node, a physical random access channel (PRACH) configuration associated with multiple UE feature combinations supported by the network node; and transmitting, to the network node, a PRACH message including a UE feature indicator in a RACH occasion associated with the PRACH configuration.

Aspect 2: The method of Aspect 1, further comprising: monitoring at least one random access search space for a random access response (RAR) message including a confirmation indication associated with the UE feature indicator.

Aspect 3: The method of any of Aspects 1-2, further comprising: retransmitting, to the network node, the PRACH message in accordance with not receiving the RAR message within an RAR window.

Aspect 4: The method of any of Aspects 1-3, further comprising: receiving, from the network node, the RAR message including the confirmation indication associated with the UE feature indicator; and retransmitting, to the network node, the PRACH message based on the confirmation indication failing to match the UE feature indicator.

Aspect 5: The method of any of Aspects 1-4, further comprising: receiving, from the network node, the RAR message including the confirmation indication associated with the UE feature indicator; and transmitting, to the network node, a PUSCH payload in an uplink grant indicated in the RAR message based on the confirmation indication matching the UE feature indicator.

Aspect 6: The method of any of Aspects 1-5, further comprising: receiving, from the network node, an indication of the multiple UE feature combinations supported by the network node.

Aspect 7: The method of any of Aspects 1-6, wherein the indication of the multiple UE feature combinations is carried in a system information block.

Aspect 8: The method of any of Aspects 1-7, wherein the indication of the multiple UE feature combinations indicates a mapping between each of the multiple UE feature combinations and an index associated with the UE feature indicator.

Aspect 9: The method of any of Aspects 1-8, wherein: the PRACH message further includes a preamble associated with a first sequence, and the first sequence is independent of a second sequence associated with the UE feature indicator.

Aspect 10: The method of any of Aspects 1-9, wherein the UE feature indicator is a medium access control-control element (MAC-CE) included in a physical uplink shared channel (PUSCH) payload.

Aspect 11: The method of any of Aspects 1-10, wherein the UE feature indicator is a UCI message multiplexed in a physical uplink shared channel (PUSCH) payload.

Aspect 12: A method of wireless communication performed by a network node, comprising: transmitting, to a user equipment (UE), a physical random access channel (PRACH) configuration associated with multiple UE feature combinations supported by the network node; receiving, from the UE, a PRACH message including a UE feature indicator in a RACH occasion associated with the PRACH configuration; and transmitting, to the UE, a random access response (RAR) message including a confirmation indication associated with the UE feature indicator.

Aspect 13: The method of Aspect 12, further comprising: receiving, from the UE, a retransmission of the PRACH configuration in accordance with the UE not receiving the RAR message within an RAR window.

Aspect 14: The method of any of Aspects 12-13, further comprising: receiving, from the UE, a retransmission of the PRACH message based on the UE determining that the confirmation indication fails to match the UE feature indicator.

Aspect 15: The method of any of Aspects 12-14, further comprising: receiving, from the UE, a PUSCH payload in an uplink grant indicated in the RAR message based on the confirmation indication matching the UE feature indicator.

Aspect 16: The method of any of Aspects 12-15, further comprising: transmitting, to the UE, an indication of the multiple UE feature combinations supported by the network node.

Aspect 17: The method of any of Aspects 12-16, wherein the indication of the multiple UE feature combinations is carried in a system information block.

Aspect 18: The method of any of Aspects 12-17, wherein the indication of the multiple UE feature combinations indicates a mapping between each of the multiple UE feature combinations and an index associated with the UE feature indicator.

Aspect 19: The method of any of Aspects 12-18, wherein: the PRACH message further includes a preamble associated with a first sequence; and the first sequence is independent of a second sequence associated with the UE feature indicator.

Aspect 20: The method of any of Aspects 12-19, wherein: the UE feature indicator is a medium access control-control element (MAC-CE) transmitted in a physical uplink shared channel (PUSCH) payload.

Aspect 21: The method of any of Aspects 12-20, wherein the UE feature indicator is an uplink control information (UCI) message multiplexed in a physical uplink shared channel (PUSCH) payload.

Aspect 22: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-21.

Aspect 23: An apparatus for wireless communication at a device, the apparatus comprising one or more memories and one or more processors coupled to the one or more memories, the one or more processors configured to cause the device to perform the method of one or more of Aspects 1-21.

Aspect 24: An apparatus for wireless communication, the apparatus comprising at least one means for performing the method of one or more of Aspects 1-21.

Aspect 25: A non-transitory computer-readable medium storing code for wireless communication, the code comprising instructions executable by one or more processors to perform the method of one or more of Aspects 1-21.

Aspect 26: A non-transitory computer-readable medium storing a set of instructions for wireless communication, the set of instructions comprising one or more instructions that, when executed by one or more processors of a device, cause the device to perform the method of one or more of Aspects 1-21.

Aspect 27: A device for wireless communication, the device comprising a processing system that includes one or more processors and one or more memories coupled with the one or more processors, the processing system configured to cause the device to perform the method of one or more of Aspects 1-21.

Aspect 28: An apparatus for wireless communication at a device, the apparatus comprising one or more memories and one or more processors coupled to the one or more memories, the one or more processors individually or collectively configured to cause the device to perform the method of one or more of Aspects 1-21.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. An apparatus for wireless communication, comprising:
one or more memories; and
one or more processors coupled to the one or more memories, the one or more processors individually or collectively configured to:
receive, from a network node, a physical random access channel (PRACH) configuration associated with multiple user equipment (UE) feature combinations supported by the network node; and
transmit, to the network node, a PRACH message including a UE feature indicator in a RACH occasion associated with the PRACH configuration.

2. The apparatus of claim 1, wherein the one or more processors are further configured to:
monitor at least one random access search space for a random access response (RAR) message including a confirmation indication associated with the UE feature indicator.

3. The apparatus of claim 2, wherein the one or more processors are further configured to:
retransmit, to the network node, the PRACH message in accordance with not receiving the RAR message within an RAR window.

4. The apparatus of claim 2, wherein the one or more processors are further configured to:
receive, from the network node, the RAR message including the confirmation indication associated with the UE feature indicator; and
retransmit, to the network node, the PRACH message based on the confirmation indication failing to match the UE feature indicator.

5. The apparatus of claim 2, wherein the one or more processors are further configured to:
receive, from the network node, the RAR message including the confirmation indication associated with the UE feature indicator; and
transmit, to the network node, a PUSCH payload in an uplink grant indicated in the RAR message based on the confirmation indication matching the UE feature indicator.

6. The apparatus of claim 1, wherein the one or more processors are further configured to:
receive, from the network node, an indication of the multiple UE feature combinations supported by the network node.

7. The apparatus of claim 6, wherein the indication of the multiple UE feature combinations indicates a mapping between each of the multiple UE feature combinations and an index associated with the UE feature indicator.

8. An apparatus for wireless communication, comprising:
one or more memories; and
one or more processors coupled to the one or more memories, the one or more processors individually or collectively configured to:
transmit, to a user equipment (UE), a physical random access channel (PRACH) configuration associated with multiple UE feature combinations supported by the apparatus;
receive, from the UE, a PRACH message including a UE feature indicator in a RACH occasion associated with the PRACH configuration; and
transmit, to the UE, a random access response (RAR) message including a confirmation indication associated with the UE feature indicator.

9. The apparatus of claim 8, wherein the one or more processors are further configured to:
receive, from the UE, a retransmission of the PRACH message.

10. The apparatus of claim 8, wherein the one or more processors are further configured to:
transmit, to the UE, an indication of the multiple UE feature combinations supported by the apparatus.

11. The apparatus of claim 8, wherein the one or more processors are further configured to:
receive, from the UE, a PUSCH payload in an uplink grant indicated in the RAR message based on the confirmation indication matching the UE feature indicator.

12. The apparatus of claim 8, wherein:
the PRACH message further includes a preamble associated with a first sequence, and
the first sequence is independent of a second sequence associated with the UE feature indicator.

13. The apparatus of claim 8, wherein the UE feature indicator is a medium access control-control element (MAC-CE) transmitted in a physical uplink shared channel (PUSCH) payload.

14. The apparatus of claim 8, wherein the UE feature indicator is an uplink control information (UCI) message multiplexed in a physical uplink shared channel (PUSCH) payload.

15. A method of wireless communication performed by a user equipment (UE), comprising:
receiving, from a network node, a physical random access channel (PRACH) configuration associated with multiple UE feature combinations supported by the network node; and
transmitting, to the network node, a PRACH message including a UE feature indicator in a RACH occasion associated with the PRACH configuration.

16. The method of claim 15, further comprising:
monitoring at least one random access search space for a random access response (RAR) message including a confirmation indication associated with the UE feature indicator.

17. The method of claim 16, further comprising:
retransmitting, to the network node, the PRACH message in accordance with not receiving the RAR message within an RAR window.

18. The method of claim 16, further comprising:
receiving, from the network node, the RAR message including the confirmation indication associated with the UE feature indicator; and
retransmitting, to the network node, the PRACH message based on the confirmation indication failing to match the UE feature indicator.

19. The method of claim 16, further comprising:
receiving, from the network node, the RAR message including the confirmation indication associated with the UE feature indicator; and
transmitting, to the network node, a PUSCH payload in an uplink grant indicated in the RAR message based on the confirmation indication matching the UE feature indicator.

20. The method of claim 15, further comprising:
receiving, from the network node, an indication of the multiple UE feature combinations supported by the network node.
